(19) United States
(12) Patent Application Publication
(10) Pub. No.: US 2010/0023881 A1
(43) Pub. Date: Jan. 28, 2010

(54) DEFINING SECTIONAL BOUNDARIES OF A WEBPAGE

(76) Inventors: Frank L. Jania, Chapel Hill, NC (US); Lisa A. Seacat, San Francisco, CA (US)

Correspondence Address: LAW OFFICE OF JIM BOICE, 3839 BEE CAVE ROAD, SUITE 201, WEST LAKE HILLS, TX, 78746, US

(21) Appl. No.: 12/178,197

(22) Filed: Jul. 23, 2008

(51) Int. Cl. G06F 3/00

(52) U.S. Cl. 715/760

(57) ABSTRACT

Disclosed are a method, system and computer program product for defining sectional boundaries of a webpage to enable efficient navigation of the content on a user device. Logical sections in a webpage are defined by comparing structured content in the webpage, analyzing patterns in a markup of the webpage, or allowing a user to identify sectional boundaries manually using an assistive user interface. A user, via a user interface, can verify or modify the sections by comparing structured content or analyzing patterns in a markup in the webpage. Indices are created by marking sectional boundaries at a beginning of each section. The webpage can be navigated by section marked by the sectional boundaries using a button pair, a user interface marker that allows direct access to sections, or a proxy for manual input by a user, such as voice input.

### BACKGROUND

1. Technical Field

The present invention generally relates to computer systems and in particular to defining sectional boundaries of a webpage to enable a user to navigate the webpage by sections marked by the sectional boundaries.

2. Description of the Related Art

Current methods of browsing content on a portable handheld device, such as a Blackberry™ device, require a user to scroll line by line or page by page. On these devices, a page may be rendered in such a way that an individual article or section may be five or six pages in length. Currently, viewing large articles or sections of web pages on a user device, such as a portable handheld device, is achieved by vertical scrolling. However, vertical scrolling is particularly challenging for users of a portable handheld device, since most portable handheld devices have a small screen and may lack a mechanism for vertical scrolling. While some portable handheld devices have a touch screen or a keypad with directional arrows or scroll bars/buttons for use in navigating around displayed content, some portable handheld devices require a user to navigate around displayed content via a stylus instead of a mouse. There is a large amount of content on the web that is sectioned so that a user can distinguish between content boundaries. However, a computer cannot make such a distinction between content boundaries.

### SUMMARY OF ILLUSTRATIVE EMBODIMENTS

Disclosed are a method, system and computer program product for defining sectional boundaries of a webpage to enable efficient navigation of the content on a user device. Logical sections in a webpage are defined by comparing structured content in the webpage, analyzing patterns in a markup of the webpage, or allowing a user to identify sectional boundaries manually using an assistive user interface. A user, via a user interface, can verify or modify the sections by comparing structured content or analyzing patterns in a markup in the webpage. Indices are created by marking sectional boundaries at a beginning of each section. The webpage can be navigated by section marked by the sectional boundaries using a button pair, a user interface marker that allows direct access to sections, or a proxy for manual input by a user, such as voice input.

The above as well as additional features and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a block diagram of a portable handheld device configured with hardware and software components for implementing one or more embodiments of the invention;

FIG. 2 is a diagram of a webpage having defined sectional boundaries, in accordance with one embodiment of the invention;

FIG. 3 is a diagram of a display of a portable handheld device on which one embodiment of the invention may be implemented; and

FIG. 4 is a flow chart of the process by which the features of the invention are implemented, according to one embodiment of the invention.

### DETAILED DESCRIPTION OF AN ILLUSTRATIVE EMBODIMENT

The illustrative embodiments provide a method, system and computer program product for defining sectional boundaries of a webpage to enable efficient navigation of the content on a user device. Logical sections in a webpage are defined by comparing structured content in the webpage, analyzing patterns in a markup of the webpage, or allowing a user to identify sectional boundaries manually using an assistive user interface. A user, via a user interface, can verify or modify the sections by comparing structured content or analyzing patterns in a markup in the webpage. Indices are created by marking sectional boundaries at a beginning of each section. The webpage can be navigated by section marked by the sectional boundaries using a button pair, a user interface marker that allows direct access to sections, or a proxy for manual input by a user, such as voice input.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

Within the descriptions of the figures, similar elements are provided similar names and reference numerals as those of the previous figure(s). Where a later figure utilizes the element in a different context or with different functionality, the element is provided a different leading numeral representative of the figure number. The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

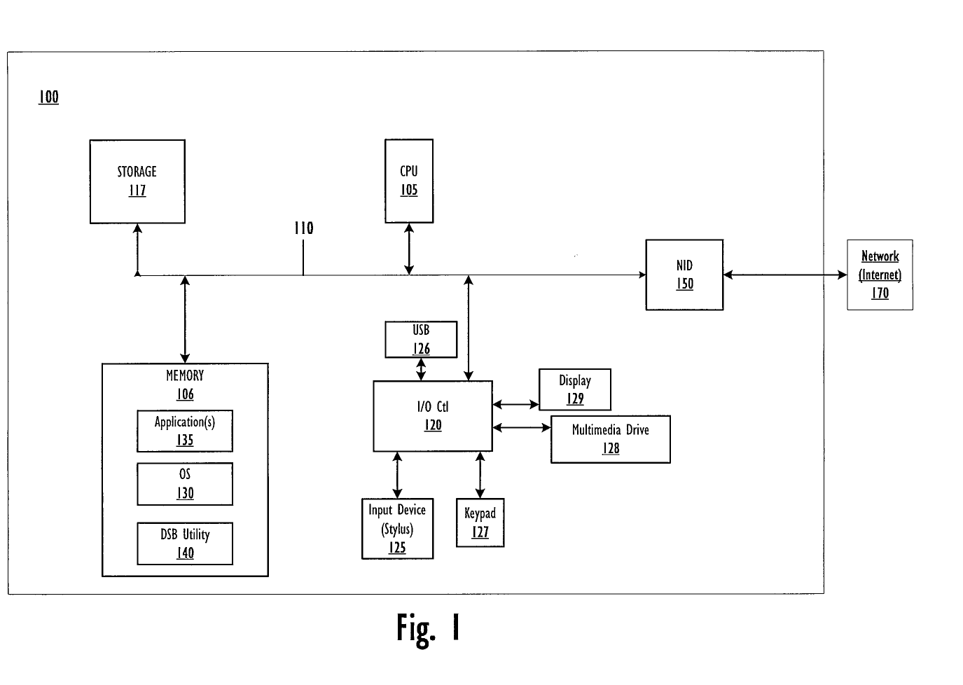

With reference now to the figures, FIG. 1, depicts a block diagram representation of a portable handheld device (PHD) 100 (and connected network). PHD 100 comprises at least one processor or central processing unit (CPU) 105 connected to system memory 106 via system interconnect/bus 110. System memory 106 is defined as a lowest level of volatile memory, including, but not limited to, cache memory, registers, and buffers. Also connected to system bus 110 is I/O controller 120, which provides connectivity and control for input devices, of which pointing device (or stylus) 125 and keypad 127 are illustrated, and output devices, of which display 129 is illustrated. Additionally, a multimedia drive 128 (e.g., CDRW or DVD drive) and USB (universal serial bus) port 126 are illustrated, coupled to I/O controller. Multimedia drive 128 and USB port 126 may operate as both input and output (storage) mechanisms. PHD 100 also comprises storage 117, within which data/instructions/code may be stored.

PHD 100 is also illustrated with network interface device (NID) 150 coupled to system bus 110. NID 150 enables PHD 100 to connect to one or more access networks 170, such as the Internet.

Notably, in addition to the above described hardware components of PHD 100, various features of the invention are completed via software (or firmware) code or logic stored within memory 106 or other storage (e.g., storage 117) and executed by CPU 105. In one embodiment, data/instructions/code from storage 117 populates the system memory 106. Thus, illustrated within memory 106 are a number of software/firmware components, including operating system (OS) 130 (e.g., Microsoft Windows®, a trademark of Microsoft Corp, or GNU®/Linux®, registered trademarks of the Free Software Foundation and The Linux Mark Institute, or Advanced Interactive eXecutive -AIX-, registered trademark of International Business Machines—IBM), web browser application 135, and Defined Sectional Boundaries (DSB) utility 140. A webpage can be viewed on a display 129 of the PHD 100.

In actual implementation, web browser application 135 and DSB utility 140 may be combined as a single application collectively providing the various functions of each individual software component when the corresponding code is executed by the CPU 105. For simplicity, DSB utility 140 is illustrated and described as a stand alone or separate software/firmware component, which is stored in system memory 106 to provide/support the specific novel functions described herein.

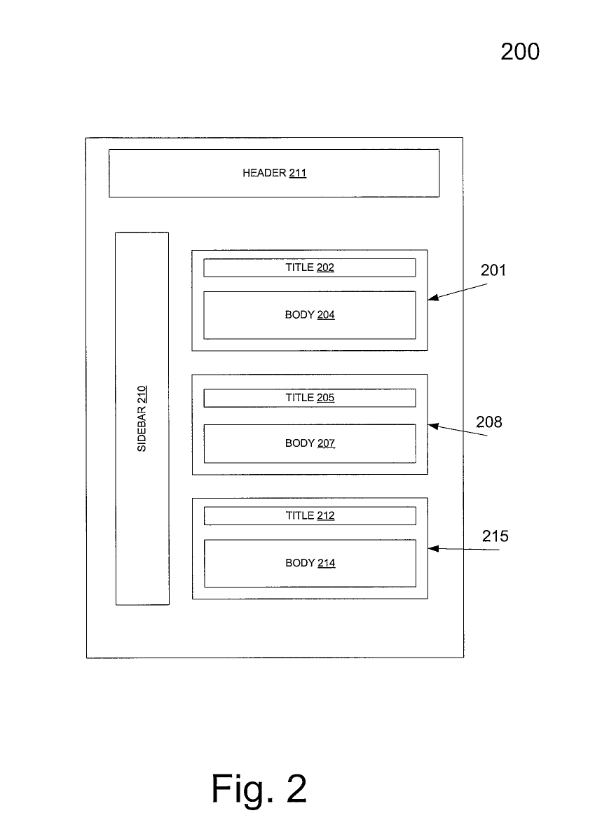

CPU 105 executes DSB utility 140 as well as OS 130, which supports the user interface features of DSB utility 140. In the illustrative embodiment, DSB utility 140 generates/provides several graphical user interfaces (GUI) to enable user interaction with, or manipulation of, the functional features of the utility (140). Among the software code/instructions provided by DSB utility 140, and which are specific to the invention, are: (a) code for detecting content patterns in a webpage; (b) code for creating indices marking sectional boundaries at a beginning of each section; and (c) code for navigating the webpage by sections marked by the sectional boundaries. For simplicity of the description, the collective body of code that enables these various features is referred to herein as DSB utility 140. According to the illustrative embodiment, when CPU 105 executes DSB utility 140, PHD 100 initiates a series of functional processes that enable the above functional features as well as additional features/functionality, which are described below within the description of FIGS. 2-4.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention.

With reference now to FIG. 2, a diagram of a webpage having defined sectional boundaries 200 is shown. The webpage 200 of FIG. 2 shows the content of a webpage as it appears on a regular-sized display screen of a desktop computer. The webpage 200 is clearly broken into repeating sections of content that contain a series of articles, blog postings, or sections. A “blog” as used herein consists of a post, or an entry. A “post” consists of a title, body, author, and date and time of the post. A single post is equivalent to a section. When a user is viewing the webpage content on a portable handheld device, such as a Blackberry™ device, the page will be rendered in such a way that an individual article or section may be five or six pages in length. While a user can scroll line by line, or page by page, it would be more efficient to scroll article by article, post by post, or section by section.

In FIG. 2, the webpage 200 has a header 211, which usually includes a webpage title. The webpage 200 also has a sidebar 210. As shown in FIG. 2, the webpage has five components (210, 211, 201, 208, 215), having six nested components therein (202, 204, 205, 207, 212, 214). The webpage has a first post 201, having a title 202 and body 204. The first post 201 makes up a first section to which a user may scroll. A second post 208 includes a title 205 and body 207. A third post 215 also includes a title 212 and body 214. The repeat of a Hypertext Markup Language (HTML) markup is an indicator that the content in these sections, articles, or posts 201, 208, 215 are separate and may be unrelated.

Sectional boundaries of the webpage 200 are defined by identifying logical sections in the webpage 200. Logical sections in the webpage 200 can be identified by comparing structured content in the webpage 200, analyzing patterns in a markup in the webpage 200, or allowing a user to identify sectional boundaries manually using an assistive user interface. A user can verify or modify, via a user interface, logical sections that are identified by (a) comparing structured content in the webpage 200, or (b) analyzing patterns in a markup of the webpage 200. Indices can be created by marking sectional boundaries at a beginning of each section or post 201, 208, 215 such as the title 202, 205, 212. A user viewing this webpage 200 on a portable handheld device can navigate the webpage 200 by scrolling from the first post 201, to the second post 208, and to the third post 215, using a button pair, such as a page up or page down button, a user interface marker that allows direct access to sections, or a proxy for manual input by a user, such as voice input, to move from one section to the other.

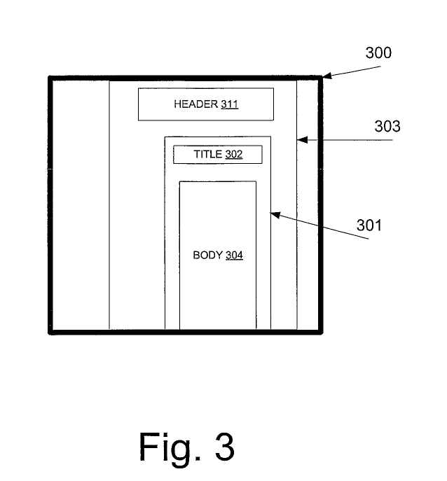

FIG. 3 shows a diagram of a portable handheld device display 300 on which one embodiment of the invention may be practiced. The display 300 is a small screen used for displaying content, such as the webpage from FIG. 2. The webpage 303 has a header 311 and at least one article, post, or section 301. The section 301 includes a title 302 and a body 304. However, when the webpage from FIG. 2, which shows the webpage as viewed from a desktop computer screen, is displayed on the small screen display 300 of the portable handheld device, as shown in FIG. 3, a smaller portion of the webpage 303 is visible at a time than in the example shown in FIG. 2. The first two sections of the webpage 303 are visible in the example shown in FIG. 2, while only a portion of the first section of the webpage 303 is visible on the portable handheld device in FIG. 3. In order to display webpage content on a small display 300, the content is usually more narrow and elongated, which results in increased length of sections 301, i.e. a section 301 displayed on one page of a regular computer display could take up to two pages or more on a small device display 300. This causes scrolling line by line or page by page to be cumbersome when searching for a particular section 301.

A user can navigate the webpage on the portable handheld device using, for example, a “3” key as a PgUp key, and a “9” key as a PgDn key to scroll page by page. To enable a user to scroll a webpage 303 by section, sectional boundaries in the webpage must be defined. Logical sections in a webpage are identified. The logical sections can be identified by the utility comparing structured content of the webpage or analyzing patterns in a markup in the webpage. The logical sections can also be identified by allowing the user to identify sectional boundaries manually using an assistive user interface. Indices are created marking the sectional boundaries at a beginning of each section or detected content pattern. The webpage can be navigated by section marked by the sectional boundaries. In one embodiment, the webpage is navigated via a button pair, such as using a “2” key to scroll up by section, and an “8” key to scroll down by section. Also, in an alternative embodiment, the webpage is navigated with a user interface marker that allows direct access to sections, or a proxy for manual input by a user, such as voice input.

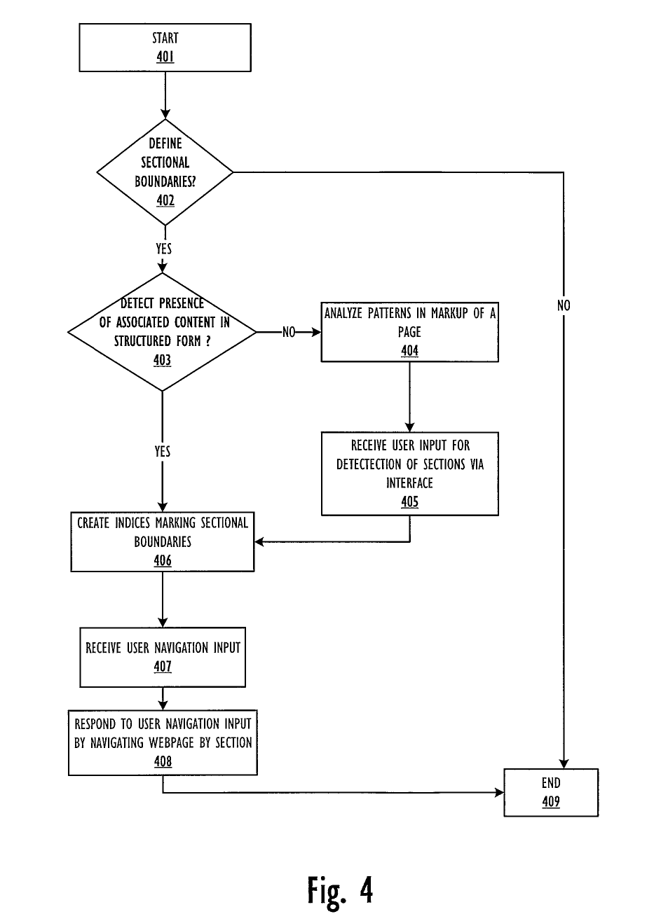

FIG. 4 is a flow chart illustrating one method by which the above process of the illustrative embodiments is completed. Although the method illustrated in FIG. 4 may be described with reference to components shown in FIGS. 1, 2, and 3, it should be understood that this is merely for convenience and alternative components and/or configurations thereof can be employed when implementing the method. Key portions of the method may be completed by DSB utility 140 executing within PHD 100 (FIG. 1) and controlling specific operations of/on PHD 100, and the methods are thus described from the perspective of either/both DSB utility 140 and PHD 100.

The process of FIG. 4 begins at initiator block 401 and proceeds to block 402, at which a user determines whether there are sections for which sectional boundaries should be identified, block 402. If sectional boundaries definition is not required, the content is presented as a single content across one or more pages, and the process ends, block 409. If sectional boundaries are to be defined, a determination is made regarding whether the presence of associated content in structured form is detected, block 403. Sectional boundaries are defined by identifying logical sections in a webpage, by comparing structured content of the webpage, analyzing patterns in a markup in the webpage, or allowing a user to identify sectional boundaries manually using an assistive user interface. If the system cannot detect the presence of associated content in structured form, patterns in a markup of a webpage are analyzed, block 404. Also, a user may assist with the detection of logical sections via user interface, block 405. Then indices are created marking sectional boundaries, block 406. A user may verify or modify logical sections identified by comparing structured content of the webpage or analyzing patterns in a markup in the webpage via a user interface. The user opens the “assist GUI” and inserts boundaries in the content of the webpage.

If the presence of associated content in structured form is detected, indices are created by marking sectional boundaries at a beginning of each defined section, block 406. A user can then navigate the webpage using a button pair that acts similar to PgUp/PgDn buttons, but jumps one section at a time, regardless of section length. The user can also navigate sections on a webpage using a user interface marker that allows direct access to sections, such as a scrollbar, tabbed index list, or scroll wheel. A user can also navigate sections on a webpage using a proxy for manual input by a user (e.g., voice input). User navigation input is received by the system, block 407. The system responds to the user navigation input, block 408, by navigating by section marked by the sectional boundaries. Once the user has completed navigating the webpage by section, the process ends, block 409.

In the flow chart above, one method is embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The method of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A system for defining sectional boundaries of a webpage, comprising:
a processor;
a storage facility;
a memory having stored thereon a utility which executes on the processor to provide the functions of:
identifying logical sections in a webpage;
creating indices marking the sectional boundaries;
receiving a navigation request; and
responding to the received navigation request by navigating the webpage by section marked by the sectional boundaries.

2. The system of claim 1, said utility further comprising program code executing on the processor for identifying logical sections by comparing structured content in the webpage.

3. The system of claim 1, said utility further comprising program code executing on the processor for identifying logical sections by analyzing patterns in a markup in the webpage.

4. The system of claim 1, said utility further comprising program code executing on the processor for generating a user interface to allow a user to identify sectional boundaries manually.

5. The system of claim 4, said utility further comprising program code executing on the processor for receiving a user input of one or more of a button pair, a user interface marker that allows direct access to sections, and a proxy for manual input by a user entered via the user interface.

6. The system of claim 4, said utility further comprising program code executing on the processor for verifying or modifying the logical sections based on the received user input by comparing structured content of the webpage.

7. The system of claim 3, said utility further comprising program code executing on the processor for verifying or modifying the logical sections based on the received user input by analyzing patterns in a markup in the webpage.

8. A method for defining sectional boundaries of a webpage, comprising:
identifying logical sections in a webpage;
creating indices marking the sectional boundaries;
receiving a navigation request; and
responding to the received navigation request by navigating the webpage by section marked by the sectional boundaries.

9. The method of claim 8, further comprising identifying logical sections by comparing structured content in the webpage.

10. The method of claim 8, further comprising identifying logical sections by analyzing patterns in a markup in the webpage.

11. The method of claim 8, further comprising generating a user interface to allow a user to identify sectional boundaries manually.

12. The method of claim 11, further comprising receiving a user input of one or more of a button pair, a user interface marker that allows direct access to sections, and a proxy for manual input by a user entered via the user interface.

13. The method of claim 12, further comprising verifying or modifying the logical sections based on the received user input by comparing structured content of the webpage.

14. The method of claim 12, further comprising verifying or modifying the logical sections based on the received user input by analyzing patterns in a markup in the webpage.

15. A computer program product having code recorded on a computer readable medium for defining sectional boundaries of a webpage, said program product comprising code for:
identifying logical sections in a webpage;
creating indices marking the sectional boundaries;
receiving a navigation request; and
responding to the received navigation request by navigating the webpage by section marked by the sectional boundaries.

16. The computer program product of claim 15, further comprising code for identifying logical sections by comparing structured content in the webpage.

17. The computer program product of claim 15, further comprising code for identifying logical sections by analyzing patterns in a markup in the webpage.

18. The computer program product of claim 15, further comprising code for generating a user interface to allow a user to identify sectional boundaries manually.

19. The computer program product of claim 18, further comprising code for receiving a user input of one or more of a button pair, a user interface marker that allows direct access to sections, and a proxy for manual input by a user entered via the user interface.

20. The computer program product of claim 15, further comprising code for:
verifying or modifying the logical sections based on the received user input by comparing structured content of the webpage; and
verifying or modifying the logical sections based on the received user input by analyzing patterns in a markup in the webpage.
